(19) United States
(12) Patent Application Publication
(10) Pub. No.: US 2021/0307331 A1
(43) Pub. Date: Oct. 7, 2021

(54) HERBICIDE COMPOSITIONS COMPRISING ETHOXYLATED LECITHIN

(71) Applicant: Albaugh, LLC, Ankeny, IA (US)

(72) Inventors: Nongnuch Sutivisedsak, Madison, WI (US); Keith Rowley, Madison, WI (US); Bret Corbett, Middlesex, NC (US); Steve Jedrzejek, Middlesex, NC (US)

(21) Appl. No.: 17/212,907

(22) Filed: Mar. 25, 2021

Related U.S. Application Data
(60) Provisional application No. 63/000,214, filed on Mar. 26, 2020.

(51) Int. Cl. A01N 57/12; A01N 43/42

(52) U.S. Cl. CPC A01N 57/12; A01N 43/42

(57) ABSTRACT

The invention provides herbicidal compositions and methods for weed control with the herbicidal compositions comprising auxin or auxin-like herbicide and ethoxylated lecithin. The undesired vegetation may be controlled using the herbicidal compositions and methods within and without damage to agricultural crops, turf grasses, or ornamental plants. The herbicidal compositions and methods of use disclosed provide for the improvement in post-emergence undesired vegetation control.

This application claims the priority of U.S. Provisional Patent Application 63/000,214, filed Mar. 26, 2020, the disclosure of which is incorporated herein by reference in its entirety.

### BACKGROUND OF THE INVENTION

### Field if the Invention

The present disclosure relates to compositions comprising an auxin or auxin-like herbicide and ethoxylated lecithin and methods of use thereof for the control undesired vegetation such as a weeds.

### Description of the Related Art

There are two primary types of herbicide applications in turf systems, pre-emergence herbicides and post-emergence herbicides. Pre-emergence herbicides prevent weeds from germinating into an actively growing plant while post-emergence herbicides will kill or stunt the actively growing unwanted weeds.

Pre-emergence herbicides are herbicides that are applied prior to weed germination. These herbicides do not prevent weeds from germinating, but rather stop the formation of the undesired plants at a vulnerable growth stage. Pre-emergence herbicides are very effective at preventing both annual and perennial weeds from emerging. However, in order to provide season-long control most pre-emergence herbicides require multiple applications in a growing season.

Post-emergence herbicides are another effective tool used to control germinated weeds. These herbicides can be used in site specific areas where weeds have germinated. Many post-emergence herbicides can target specific weeds while not disrupting the desirable vegetation. Some post-emergence herbicides often work best at certain life stages of the weeds and multiple applications are needed for effective control. For example, quinclorac (3,7-dichloro-8-quinolinecarboxylic acid) does not adequately control crabgrass between the 2-4 tiller stages of growth. Often several sequential applications will be required for crabgrass control at this life stage. However, quinclorac can be efficacious when applied prior to the 2 tiller growth stage and growth stages of 5 or more tillers with one application.

A post-emergence herbicide, such as quinclorac, that would provide accelerated and complete control in a single application at any life stage of weeds such as crabgrass, and broadleaves without causing injury to the surrounding turf swards would be beneficial.

### SUMMARY

Disclosed herein are compositions comprising an auxin or auxin-like herbicide and ethoxylated lecithin. In some embodiments, the auxin or auxin-like herbicide is a quinoline carboxylic acid and/or salts thereof. In some embodiments, the auxin or auxin-like herbicide is quinclorac. In some embodiments the auxin or auxin-like herbicide is quinclorac and its esters or salts. The composition may be a solution.

The composition may comprise a weight percent ratio of the auxin-like herbicide to the ethoxylated lecithin of 0.8:1.0 to 8.0:1.0. In some embodiments, the composition comprises a weight percent ratio of the auxin-like herbicide to the ethoxylated lecithin of 1.8:1.

In some embodiments, the composition further comprises a surfactant. In some embodiments, the composition further comprises a crop oil concentrate, a methylated seed oil, or a combination thereof. In some embodiments, the composition further comprises a solvent.

Also disclosed herein are methods comprising applying at least one application of the compositions described herein to undesired vegetation. In some embodiments, the undesired vegetation comprises crabgrass. In some embodiments, the composition increases death of the undesired vegetation compared to a composition lacking ethoxylated lecithin.

The method may comprise between one and five applications. In some embodiments, the method comprises one application. In some embodiments, the application is applied after emergence of the undesired vegetation. In some embodiments, the applying comprises spraying.

In some embodiments, the composition is applied in sufficient amounts to supply the auxin or auxin-like herbicide at about 20 to 100 fl oz per acre. In some embodiments, the composition is applied at a rate sufficient to supply 0.1 to 2.0 lb auxin or auxin-like herbicide per acre.

Other aspects and embodiments of the disclosure which constitute part of the invention, will be apparent in light of the following detailed description.

### DETAILED DESCRIPTION

The present disclosure provides compositions comprising an auxin or auxin-like herbicide (e.g., quinclorac) and ethoxylated lecithin which deliver unexpected post-emergence control of certain broadleaves and weedy grasses in turf swards.

The disclosure further provides a method for post-emergence control of crabgrass in turf swards with a single application of a composition comprising an auxin or auxin-like herbicide (e.g., quinclorac) and ethoxylated lecithin.

Section headings as used in this section and the entire disclosure herein are merely for organizational purposes and are not intended to be limiting.

### 1. DEFINITIONS

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Unless otherwise defined herein, scientific and technical terms used in connection with the present disclosure shall have the meanings that are commonly understood by those of ordinary skill in the art. For example, any nomenclatures used in connection with, and techniques of, cell and tissue culture, molecular biology, immunology, microbiology, genetics and protein and nucleic acid chemistry and hybridization described herein are those that are well known and commonly used in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

“Herbicide” as used herein refers to a chemical substance used to control undesired vegetation. Herbicides are commonly known as weed killers. Herbicides comprise an active ingredient that kills, controls, or otherwise adversely modifies the growth of vegetation. An “herbicidal effect” as used herein refers to an adversely modifying effect on plants and includes deviations from, for instance, natural development, killing, regulation, desiccation, and retardation. An “herbicidally-effective amount” as used herein refers to an amount of an active ingredient that causes an herbicidal effect.

“Crop oil concentrate” and “COC” are used interchangeably herein to refer to an emulsifiable petroleum oil-based product containing 15 to 20% w/w surfactant and a minimum of 80% w/w phytobland oil.

Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

### 2. COMPOSITIONS

Provided herein are compositions comprising an herbicide and ethoxylated lecithin. The composition may comprise an auxin or auxin-like herbicide and ethoxylated lecithin.

Auxin or auxin-like herbicides are growth regulating herbicides that are generally used for controlling broadleaf weeds in grass crops, pastures, and industrial plantings. The auxin or auxin-like herbicide may be synthetic (e.g. group 4 herbicides) or derived from natural sources (endogenous plant auxins). Synthetic auxins include, for example, the following herbicide families: benzoic acids (e.g. dicamba); phenoxycarboxylic acids (e.g. 2,4-D (2,4-dichlorophenoxyacetic acid), 2,4-DB (4-(2,4-dichlorophenoxy)butyric acid); MCPA (2-methyl-4-chlorophenoxyacetic acid), MCPB (4-(4-chloro-o-tolyloxy)butyric acid (IUPAC), or 4-(4-chloro-2-methylphenoxy)butanoic acid (CAS)), Mecoprop (methylchlorophenoxypropionic acid)); pyridine carboxylic acids (e.g. clopyralid (3,6-dichloro-2-pyridinecarboxylic acid), fluroxypyr ([(4-amino-3,5-dichloro-6-fluoro-2-pyridinyl)oxy]acetic acid), picloram (4-amino-3,5,6-trichloro-2-pyridinecarboxylic acid), triclopyr ([(3,5,6-Trichloro-2-pyridinyl)oxy]acetic acid), aminopyralid (4-amino-3,6-dichloropyridine-2-carboxylic acid), aminocyclopyrachlor (6-amino-5-chloro-2-cyclopropylpyrimidine-4-carboxylic acid)); and quinoline carboxylic acids (e.g. quinclorac). The synthetic auxins act similar to that of an endogenous plant auxin.

In some embodiments, the auxin or auxin-like herbicide is a quinoline carboxylic acid and/or salts thereof. In selected embodiments, the auxin or auxin-like herbicide is quinclorac (3,7-dichloro-8-quinolinecarboxylic acid).

The auxin or auxin-like herbicide is added to the composition in acid form and a basic salt may form in situ. In some embodiments, the salt is a methyl amine salt (e.g., dimethyl amine salt and trimethyl amine salt).

Ethoxylated lecithin is the reaction product of ethylene oxide and lecithin. Lecithin is a mixture comprising a variety of phospholipids, including, for example, phosphatidylcholine, phosphatidylethanolamine, phosphatidylinositol, phosphatidylserine and phosphatidic acid. Lecithin may be derived from a variety of sources including, but not limited to soybeans (soybean oil), animal sources, and eggs. Lecithin may be non-deoiled lecithin.

Ethoxylated lecithin may include phospholipids having greater than 5 moles ethoxylate functional group incorporated therein. For example, ethoxylated lecithin may be lecithin having 25 moles ethoxylate functional group incorporated therein (having a number average molecular weight (NAVG MW) of about 1000) and/or lecithin having 30 moles ethoxylate functional group incorporated therein (having a NAVG MW of about 1200).

Phospholipid-enriched soybean oil may be reacted with 30-90 wt %, preferably 50-70 wt %, of ethylene oxide between 90° C. and 180° C., in the presence of a basic catalyst, typically potassium hydroxide, at a pressure between 1 and 5 bar for 60-300 minutes. Small amounts (e.g., 1-4 wt %) glycerol may be added as an initiator. The reaction conditions, such as time and pressure, may be set to obtain a final product comprising 10-200, preferably 20-50 ethylene oxide units. Temperature is preferably maintained below 170° C., preferably at about 160° C., to avoid excessive discoloration. An exemplary process for the production of lecithin is described in, for example, U.S. Pat. No. 2,310,679, herein incorporated by reference in its entirety.

Ethoxylated lecithin is commercially available. For example, an ethoxylated phospholipid-enriched soybean oil can be obtained from ethoxylating a soybean oil containing from 5-30 wt %, preferably 8-10 wt %, and more preferably about 10 wt % phospholipids. Triglycerides contained in the soybean oil may include, for example, C16 saturated and C18 saturated, mono-unsaturated and poly-unsaturated fatty acids, particularly palmitic, stearic, oleic, linoleic and linolenic acid. Thus, the ethoxylated lecithin products may further comprise ethoxylated fatty acids.

The composition may comprise a weight percent ratio of the auxin or auxin-like herbicide to the ethoxylated lecithin of about 0.8:1.0 to about 8.0:1.0 (e.g., about 1.0:1.0, about 2.0:1.0, or about 5.0:1.0). In some embodiments, the weight percent ratio is between 1.0:1.0 and 5.0:1.0. In selected embodiments, the weight percent ratio is between 1.0:1.0 and 2.0:1.0, for example 1.8:1.0.

The composition may contain herbicidally-effective amounts of the auxin or auxin-like herbicide. The composition may comprise between about 1% and about 50% herbicide. In some embodiments, the composition comprises about 1%, about 5%, about 10%, about 20%, about 25%, about 30%, about 35%, about 40%, about 45%, or about 50% herbicide. In exemplary embodiments, the composition comprises about 20% herbicide.

The compositions may also comprise one or more additional pesticides (e.g., herbicides, insecticides, fungicides, bactericides) or adjuvants, such as surfactants, wetting agents, defoamers, preservatives, colorants, stabilizers, solvents, preservatives, and the like.

In some embodiments, the composition further comprises a surfactant. The surfactant may comprise non-ionic surfactants, anionic surfactants, cationic surfactants and/or amphoterics. In some embodiments, the composition further comprises a crop oil concentrate, a methylated seed oil, or a combination thereof.

In select embodiments, the composition further comprises a methylated seed oil. The composition may comprise 0.25% to 5.0% (v/v) methylated seed oil. In some embodiments, the composition comprises 0.25% to 1.0% (v/v), 0.25% to 2.0% (v/v), 0.25% to 3.0% (v/v), 0.25% to 4.0% (v/v), 0.5% to 1.0% (v/v), 0.5% to 2.0% (v/v), 0.5% to 3.0% (v/v), 0.5% to 4.0% (v/v), 0.5% to 5.0% (v/v), 1.0% to 2.0% (v/v), 1.0% to 3.0% (v/v), 1.0% to 4.0% (v/v), 1.0% to 5.0% (v/v), 2.0% to 3.0% (v/v), 2.0% to 4.0% (v/v), 2.0% to 5.0% (v/v), 3.0% to 4.0% (v/v), 3.0% to 5.0% (v/v), or 4.0% to 5.0% (v/v) methylated seed oil. In select embodiments, the composition comprises about 1.0% (v/v) methylated seed oil.

The composition may be in a form selected from a granule (e.g., water dispersible granules) or a solution. In some embodiments, the composition is a solution and further comprises a solvent. The solvent may comprise water alone or combined with another aqueous solvent.

### 3. METHODS OF USE

Also disclosed herein are methods comprising applying at least one application of the composition described herein to undesired vegetation. The undesired vegetation may be within or amongst agricultural crops, turf grasses, or ornamental plants. The undesired vegetation may include, but is not limited to, grass weeds (e.g., crabgrass, kikuyugrass) and broadleaf weeds (e.g., clover, dandelion).

The composition may be applied in sufficient amounts to supply the auxin or auxin-like herbicide at about 20 fl oz (approximately 0.03 liters) per acre to about 100 fl oz per acre. In some embodiment, the composition is applied in sufficient amounts to supply the auxin or auxin-like herbicide at about at 20-50 fl oz per acre, 20-75 fl oz per acre, 35-50 fl oz per acre, 35-75 fl oz per acre, 35-100 fl oz per acre, 50-75 fl oz per acre, 50-100 fl oz per acre, 75-100 fl oz per acre. In some embodiments, the composition is applied at about 25, 35, 50, 65, or 75 fl oz per acre.

The composition may comprise the auxin or auxin-like herbicide in sufficient amounts to supply the herbicide at about 0.1 to about 2.0 lb per acre. In some embodiments, the composition comprises the auxin or auxin-like herbicide in sufficient amounts to supply the herbicide at about 0.1-0.5 lb per acre, 0.1-0.75 lb per acre, 0.1-1.0 lb per acre, 0.1-1.5 lb per acre, 0.2-2.0 lb per acre, 0.2-1.5 lb per acre, 0.2-1.0 lb per acre, 0.2-0.75 lb per acre, 0.2-0.5 lb per acre, 0.5-0.75 lb per acre 0.5-1.0 lb per acre, 0.5-1.5 lb per acre, 0.5-2.0 lb per acre, 0.75-1.0 lb per acre, 0.75-1.5 lb per acre or 0.75-2.0 lb per acre. In some embodiment the composition comprises the herbicide in sufficient amounts to supply the herbicide at about 0.25 lb per acre, about 0.5 lb per acre, about 0.75 lb per acre, about 1.0 lb per acre, or about 1.5 lb per acre.

It is understood that an application of the composition may be applied in a sufficient amount of water to achieve the desired rate of coverage. The compositions can be applied using any common technique known in the art for liquid-based pesticide application, for example, spraying, misting, wiping, and/or with rope wick applicators.

The composition may be applied before seeding agricultural crops, turf and ornamental, or industrial plants (pre-emergence of the undesired vegetation) or after emergence of the undesired vegetation (post-emergence). Preferably, the composition is applied after emergence of the undesired vegetation.

In some embodiments, more than one application of the composition can be applied as needed to maintain and control the undesired vegetation. In some embodiments, the number of applications can be between one and five. For example, one application, two applications, three applications, four applications, or five applications may be applied. In select embodiments, a single application is applied.

In some embodiments, the applications are applied periodically. For example, the subsequent applications may be applied at least about 10, at least about 20, at least about 30, at least about 40 or at least about 50 days after the initial or previous application of the composition.

Use of the composition may provide increased control of undesired vegetation over compositions lacking the ethoxylated lecithin.

### 4. EXAMPLES

### Example 1

### Post-Emergence Herbicidal Evaluation of Quinclorac Herbicide and Ethoxylated Lecithin for Control of Smooth Crabgrass (4 Tiller), White Clover, and Virginia Buttonweed

Quinclorac herbicide (QUINCLORAC 1.5L SELECT™ supplied by Prime Source, LLC) and ethoxylated lecithin (BKS-101 supplied by Exacto INC) was evaluated as a post-emergence herbicide for the control of smooth crabgrass (4 tiller), white clover and Virginia buttonweed. The evaluation was conducted on a bermudagrass (Cynodon spp.) to evaluate several quinclorac formulations for post-emergence smooth crabgrass (Digitaria ischaemum) control.

Materials and Methods. The test site was maintained as a golf course fairway with respect to irrigation, fertilization, and mowing. Height of cut measured 0.6 inches. Treatments were arranged in a randomized complete block design with four replications. Herbicide treatments were initially applied to plots (5×6 ft) using a CO₂ pressurized boom sprayer calibrated to deliver 90 gpa via four, flat-fan, 8006 nozzles at 20 psi, configured to provide a 4-ft spray swath. Smooth crabgrass was at a 4-tiller growth stage when treatments were initially applied. Sequential applications were made 21 or 40 days after initial application using the same equipment. Table 1 includes the treatments that were applied. Quinclorac Select and BSK-101 were a tank mix for treatments.

TABLE 1
Herbicide Treatments

| Herbicide Treatments* | Rate (quinclorac/A) ** |
|---|---|
| Quinclorac (Select) + MSO | 63 fl oz fb 63 fl oz fb 63 fl oz |
| Drive XLR8 + MSO | 63 fl oz fb 63 fl oz fb 63 fl oz |
| Quinclorac (Select) + MSO | 63 fl oz |
| Drive XLR8 + MSO | 63 fl oz |
| Quinclorac (Select) + BSK-101 + MSO | 63 fl oz |
| Quinclorac (Select) + BSK-101 + MSO | 63 fl oz fb 63 fl oz fb 63 fl oz |

*MSO = methylated seed oil; BSK-101 = ethoxylated lecithin; Drive XLR8 = quinclorac-based herbicide
**fb = followed by

Smooth crabgrass, white clover (Trifolium repens), and Virginia buttonweed (Diodia virginiana) control were evaluated on a 0 (i.e., no control) to 100 (i.e., complete plant death) percent scale relative to non-treated check plots in each replication. Bermudagrass injury was assessed using a similar percent scale as well.

Significant differences in smooth crabgrass control were detected among treatments. As shown in Table 2, all sequential application regimes effectively controlled smooth crabgrass during this study with control measuring 99 to 100% by 69 days after initial treatment (DAIT). Interestingly, a single application of Quinclorac (Select)+BSK-101 (Ethoxylated Lecithin)+MSO controlled smooth crabgrass 91% by 28 DAIT and 85% by 69 DAIT. Comparatively, single applications of Quinclorac (Select)+MSO and Drive XLR8+MSO only controlled smooth crabgrass 13 to 21% by 69 DAIT.

TABLE 2
Smooth Crabgrass (Digitaria ischaemum) control with herbicide treatments

| | | Smooth Crabgrass Control (%) | | | | |
|---|---|---|---|---|---|---|
| | | 14 | 28 | 42 | 56 | 69 |
| Herbicide Treatments† | Rate (quinclorac/A)* | DAIT^{‡} | DAIT | DAIT | DAIT | DAIT |
| Quinclorac (Select) + MSO | 63 fl oz fb 63 fl oz fb 63 fl oz | 83 | 100 | 99 | 100 | 100 |
| Drive XLR8 + MSO | 63 fl oz fb 63 fl oz fb 63 fl oz | 88 | 100 | 98 | 100 | 100 |
| Quinclorac (Select) + MSO | 63 fl oz | 79 | 61 | 48 | 33 | 13 |
| Drive XLR8 + MSO | 63 fl oz | 86 | 68 | 50 | 35 | 21 |
| Quinclorac (Select) + | 63 fl oz | 90 | 91 | 88 | 85 | 85 |
| BSK-101 + MSO | | | | | | |
| Quinclorac (Select) + | 63 fl oz fb 63 fl oz fb 63 fl oz | 95 | 100 | 100 | 100 | 99 |
| BSK-101 + MSO | | | | | | |

| | | | | | |
|---|---|---|---|---|---|
| LSD_{0.05} | 8 | 11 | 12 | 19 | 25 |

†Treatments were initially applied May 29, 2019. Sequential applications were made on Jun. 19, 2019 or Jul. 8, 2019. Drive XLR8 = quinclorac-based herbicide
^{‡}DAIT = days after initial treatment
*fb = followed by; MSO = methylated seed oil at 24 fl oz/A; BSK-101 = adjuvant applied at 32 fl oz/100 gallon.

Additional treatments test herbicidal application rates of 64 fl oz and 32 fl oz, in single and multiple applications.

### Example 2

### Evaluation of Prime Source Quinclorac 1.5 L Select Herbicide and Ethoxylated Lecithin for Control of Smooth Crabgrass (5-7 Tiller), Virginia Tech 2020

Quinclorac herbicide (QUINCLORAC 1.5L SELECT™ supplied by Prime Source, LLC) and ethoxylated lecithin (BKS-101 supplied by Exacto INC), and Premix of Quinclorac herbicide with ethoxylated lecithin (PS1) was evaluated as a post-emergence herbicide for the control of smooth crabgrass (5-7 tiller). The evaluation was conducted on Bermudagrass (Cynodon spp) to evaluate several quinclorac formulations for post-emergence smooth crabgrass (Digitaria ischaemum) control.

Materials and Methods. The test site was maintained as a golf course fairway with respect to irrigation, fertilization, and mowing. Height of cut measured 0.7 inches. Treatments were arranged in a randomized complete block design with four replications. Herbicide treatments were initially applied to plots (4×6 ft) using a CO₂ pressurized boom sprayer calibrated to deliver 40 gpa via four, flat-fan, 8006 nozzles at 40 psi, configured to provide a 4-ft spray swath. Smooth crabgrass was at a 5-7-tiller growth stage when treatments were initially applied. Table 1 includes the treatments that were applied. Quinclorac Select and BSK-101 were a tank mix for treatments as well as a formulated premix, PS1.

TABLE 1
Herbicide Treatments

| Herbicide Treatments* | Rate (/A) ** |
|---|---|
| Quinclorac (Select) | 24 fl oz |
| PS1 | 24 fl oz |
| Quinclorac (Select) + BSK-101 | 24 fl oz |
| Quinclorac (Select) | 32 fl oz |
| PS1 | 32 fl oz |
| Quinclorac (Select) + BSK-101 | 32 fl oz |
| Quinclorac (Select) | 48 fl oz |
| PS1 | 48 fl oz |
| Quinclorac (Select) + BSK-101 | 48 fl oz |
| Quinclorac (Select) | 64 fl oz |
| PS1 | 64 fl oz |
| Quinclorac (Select) + BSK-101 | 64 fl oz |

*BSK-101 = ethoxylated lecithin (32 fl oz/100 gal); PS1 = quinclorac herbicide formulated with 9% Ethoxylated Lecithin

Smooth crabgrass control was evaluated on a 0 (i.e., no control) to 100 (i.e., complete plant death) percent scale relative to non-treated check plots in each replication. Bermudagrass injury was assessed using a similar percent scale as well.

During the first 4 weeks of the study, we observed that the addition of BSK to Quinclorac does increase smooth crabgrass control numerically, but it rarely separated statistically. Significant differences in smooth crabgrass control were detected among treatments of PS1 and Quinclorac alone at 48 fl oz 42 DAT, As shown in Table 2. A single application of Quinclorac (Select)+BSK-101 (Ethoxylated Lecithin)+controlled smooth crabgrass 89.5% by 42 DAT and PS1 controlled smooth crabgrass 92% by 42 DAT. Comparatively, single applications of Quinclorac (Select)+ and only controlled smooth crabgrass 78.3% by 42 DAT.

TABLE 2
Smooth Crabgrass (Digitaria ischaemum)
control with herbicide treatments

| | | 7 | 14 | 29 | 42 |
|---|---|---|---|---|---|
| Herbicide Treatments | Rate (/A) | DAT | DAT | DAT | DAT |
| Quinclorac (Select) | 24 fl oz | 67.5 | 80 | 70.8 | 61.3 |
| PS1 | 24 fl oz | 72.5 | 80.8 | 78.8 | 71.5* |
| Quinclorac (Select) + | 24 fl oz | 80* | 86.3 | 75.8 | 67.5 |
| BSK-101 | | | | | |
| Quinclorac (Select) | 32 fl oz | 76.3 | 88.8 | 82 | 74.5 |
| PS1 | 32 fl oz | 83.8 | 92.5 | 85 | 79.5 |
| Quinclorac (Select) + | 32 fl oz | 84.3 | 90.8 | 86 | 77.5 |
| BSK-101 | | | | | |
| Quinclorac (Select) | 48 fl oz | 87.5 | 93 | 90.5 | 78.3 |
| PS1 | 48 fl oz | 90.8 | 94.5 | 92.3 | 92* |
| Quinclorac (Select) + | 48 fl oz | 92 | 97.8 | 96.5 | 89.5* |
| BSK-101 | | | | | |
| Quinclorac (Select) | 64 fl oz | 90.8 | 96.8 | 94.8 | 91.3 |
| PS1 | 64 fl oz | 94 | 97 | 97 | 92.5 |
| Quinclorac (Select) + | 64 fl oz | 94 | 97.5 | 98.5 | 94.8 |
| BSK-101 | | | | | |

| | | | | |
|---|---|---|---|---|
| LSD0.05 | 8.34 | 5.94 | 8.05 | 9.44 |

*Statistically Separation from Quinclorac (Select)

Additional treatments test herbicidal application rates of 64 fl oz and 32 fl oz, in single and multiple applications were applied. In conclusion, the use of PS1 or Quinclorac 1.5L plus BSK applied once at 48 or 64 fl oz/A can control smooth crabgrass effectively for 8 weeks.

### Example 3

### Postemergence Control of Smooth Crabgrass with Prime Source Quinclorac (3 Tiller), Tennessee 2020

Quinclorac herbicide (QUINCLORAC 1.5L SELECT™ supplied by Prime Source, LLC) and ethoxylated lecithin (BKS-101 supplied by Exacto INC), and Premix of Quinclorac herbicide with ethoxylated lecithin (PS1) was evaluated as a post-emergence herbicide for the control of smooth crabgrass (5-7 tiller). The evaluation was conducted on Bermudagrass (Cynodon spp) to evaluate several quinclorac formulations for post-emergence smooth crabgrass (Digitaria ischaemum) control.

Materials and Methods. The test site at ETREC was maintained as a golf course fairway with respect to irrigation, fertilization, and mowing. Height of cut measured 0.6 inches. Treatments were arranged in a randomized complete block design with four replications. Herbicide treatments were initially applied on 24 Jun. 2020 to plots (5×6 ft) using a CO₂ pressurized boom sprayer calibrated to deliver 40 gpa via four, flat-fan, 8002 nozzles at 18 psi, configured to provide a 4-ft spray swath. Smooth crabgrass plants had matured to a 3-tiller stage on the date of trial initiation.

TABLE 1
Herbicide Treatments

| Herbicide Treatments* | Rate (/A) ** |
|---|---|
| Quinclorac (Select) | 32 fl oz |
| PS1 | 32 fl oz |
| Quinclorac (Select) + BSK-101 | 32 fl oz |
| Quinclorac (Select) | 64 fl oz |
| PS1 | 64 fl oz |
| Quinclorac (Select) + BSK-101 | 64 fl oz |

*BSK-101 = ethoxylated lecithin (32 fl oz/100 gal); PS1 = quinclorac herbicide formulated with 9% Ethoxylated Lecithin Treatments were applied to plants at the 3 tiller stage on 24 June 2020 (Knoxville, TN)

Smooth crabgrass control was evaluated on a 0 (i.e., no control) to 100 (i.e., complete plant death) percent scale relative to non-treated check plots in each replication. White clover (Trifolium repens) was assessed on select dates as well. Bermudagrass injury was assessed using a similar percent scale as well.

Significant differences in smooth crabgrass control were detected among treatments in this study (Table 2). When applied at 32 fl oz/A, PS1 and Quinclorac+BSK-101 controlled smooth crabgrass greater than Quinclorac at 42 days after initial treatment (DAIT). There was a trend for increased control with Quinclorac+BSK-101 at 57 DAIT; however, it was not statistically significant. Fewer differences were detected among treatments when quinclorac was applied at 64 fl oz/A. Interestingly, there was a trend for reduced control with Quinclorac+BSK-101 by 57 DAIT, albeit not statistically significant. Reasons for this response are unclear and suggest that additional research is warranted exploring efficacy of Quinclorac+BSK-101 for postemergence smooth crabgrass control in different turfgrass scenarios. It should be noted that all treatments controlled white clover 100% by 57 DAIT as well (data not presented)

TABLE 2
Smooth Crabgrass (Digitaria ischaemum)
control with herbicide treatments

| | Rate | 22 | 42 | 57 |
|---|---|---|---|---|
| Herbicide Treatments | (/A) | DAT | DAT | DAT |
| Quinclorac (Select) | 32 fl oz | 70 | 45 | 38 |
| PS1 | 32 fl oz | 75 | 73* | 35 |
| Quinclorac (Select) + BSK-101 | 32 fl oz | 76 | 73* | 55 |
| Quinclorac (Select) | 64 fl oz | 93 | 91 | 68 |
| PS1 | 64 fl oz | 90 | 80 | 70 |
| Quinclorac (Select) + BSK-101 | 64 fl oz | 85 | 68 | 43 |

| | | | |
|---|---|---|---|
| LSD_{0.05} | 15 | 16 | 40 |

*Statistically Separation from Quinclorac (Select)

### Example 4

### Post-Emergence Herbicidal Evaluation of Quinclorac Herbicide and Ethoxylated Lecithin for Control of Smooth Crabgrass (3-4 Tiller) North Carolina 2020

Quinclorac herbicide (QUINCLORAC 1.5L SELECT™ Supplied by Prime Source, LLC) and ethoxylated lecithin (BKS-101 supplied by Exacto INC) was evaluated as a post-emergence herbicide for the control of smooth crabgrass (3-5 tiller). The evaluation was conducted on a bermudagrass (Cynodon spp.) to evaluate several quinclorac formulations for post-emergence smooth crabgrass (Digitaria ischaemum) control.

Materials and Methods. The test site was maintained as a golf course rough with respect to irrigation, fertilization, and mowing. Height of cut measured 1-1.5 inches. Treatments were arranged in a randomized complete block design with three replications. Herbicide treatments were initially applied to plots (6×6 ft) using a CO₂ pressurized boom sprayer calibrated to deliver 40 gpa via four, flat-fan, 8006 nozzles at 40 psi, configured to provide a 5-ft spray swath. Smooth crabgrass was at a 3-tiller growth stage when treatments were initially applied. Table 1 includes the treatments that were applied. Quinclorac Select and BSK-101 were a tank mix for treatments.

TABLE 1
Herbicide Treatments

| Herbicide Treatments* | Rate (/A) * |
|---|---|
| Quinclorac (Select) | 24 fl oz |
| PS1 | 24 fl oz |
| Quinclorac (Select) + BSK-101 | 24 fl oz |
| Quinclorac (Select) | 32 fl oz |
| PS1 | 32 fl oz |
| Quinclorac (Select) + BSK-101 | 32 fl oz |
| Quinclorac (Select) | 48 fl oz |
| PS1 | 48 fl oz |
| Quinclorac (Select) + BSK-101 | 48 fl oz |
| Quinclorac (Select) | 64 fl oz |
| PS1 | 64 fl oz |
| Quinclorac (Select) + BSK-101 | 64 fl oz |

*BSK-101 = ethoxylated lecithin (32 fl oz/100 gal); PS1 = quinclorac herbicide formulated with 9% Ethoxylated Lecithin; Methylated Seed Oil (MSO) was applied to every treatment Treatments were applied to plants at the 3-tiller stage on 1 June, 2020 (Wilmington, NC)

Smooth crabgrass control was evaluated on a 0 (i.e., no control) to 100 (i.e., complete plant death) percent scale relative to non-treated check plots in each replication. Bermudagrass injury was assessed using a similar percent scale as well.

Differences in smooth crabgrass control were detected among treatments. As shown in Table 2. A single application of Quinclorac (Select)+BSK-101 (Ethoxylated Lecithin) controlled smooth crabgrass 88 by 42 DAT and 83% by 63 DAT. Comparatively, single applications of Quinclorac (Select) only controlled smooth crabgrass 808 by 42 DAT and 76% by 63 DAT at 64 fl oz/A. Additionally, PS1 controlled smooth crabgrass 91% by 42 DAT and 888 by 63 DAT, compared to 80 by 42 DAT and 76% by 63 DAT at 48 fl oz/A.

TABLE 2
Smooth Crabgrass (Digitaria ischaemum)
control with herbicide treatments

| | | Smooth Crabgrass Control (%) | | | | |
|---|---|---|---|---|---|---|
| | Rate | 14 | 28 | 42 | 49 | 63 |
| Herbicide Treatments† | (/A) | DAT | DAT | DAT | DAT | DAT |
| Quinclorac (Select) | 24 fl oz | 91 | 80 | 73 | 66 | 61 |
| PS1 | 24 fl oz | 91 | 86 | 76 | 71 | 66 |
| Quinclorac (Select) + | 24 fl oz | 95 | 93 | 88 | 82 | 80 |
| BSK-101 | | | | | | |
| Quinclorac (Select) | 32 fl oz | 91 | 85 | 81 | 81 | 76 |
| PS1 | 32 fl oz | 95 | 85 | 80 | 75 | 71 |
| Quinclorac (Select) + | 32 fl oz | 95 | 90 | 86 | 83 | 93 |
| BSK-101 | | | | | | |
| Quinclorac (Select) | 48 fl oz | 91 | 86 | 80 | 76 | 76 |
| PS1 | 48 fl oz | 98 | 93 | 91 | 88 | 88 |
| Quinclorac (Select) + | 48 fl oz | 100 | 95 | 90 | 90 | 86 |
| BSK-101 | | | | | | |
| Quinclorac (Select) | 64 fl oz | 93 | 88 | 80 | 78 | 76 |
| PS1 | 64 fl oz | 98 | 91 | 83 | 83 | 80 |
| Quinclorac (Select) + | 64 fl oz | 98 | 91 | 88 | 85 | 83 |
| BSK-101 | | | | | | |

†Treatments were initially applied Jun. 1, 2020
DAT = days after initial treatment; MSO = methylated seed oil at 24 fl oz/A; BSK-101 = adjuvant applied at 32 fl oz/100 gallon.

It is understood that the foregoing detailed description and accompanying examples are merely illustrative and are not to be taken as limitations upon the scope of the disclosure, which is defined solely by the appended claims and their equivalents.

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A composition comprising quinclorac and its esters or salts and ethoxylated lecithin.

2. The composition of 2, wherein the composition comprises a weight percent ratio of quinclorac and its esters or salts to the ethoxylated lecithin of 0.8:1.0 to 8.0:1.0.

3. The composition of claim 3, wherein the composition comprises a weight percent ratio of quinclorac and its esters or salts to the ethoxylated lecithin of 1.8:1.

4. The composition of claim 4, wherein the composition comprises about between about 1% and about 50% of quinclorac and its esters or salts.

5. The composition of claim 5, wherein the composition comprises 20% quinclorac and its esters or salts.

6. The composition of claim 6, further comprising a crop oil concentrate, a methylated seed oil, or a combination thereof.

7. The composition of claim 7, wherein the composition comprises methylated seed oil, wherein the composition has a volume percent between 0.25% and 5.0% of methylated seed oil.

8. The composition of claim 8, wherein the composition comprises methylated seed oil, wherein the composition has a volume percent of 1.0% of methylated seed oil.

9. A method for controlling for controlling undesired vegetation comprising:
preparing a herbicidal composition comprising quinclorac and its esters or salts and ethoxylated lecithin; and
applying a herbicidally effective amount of the herbicidal composition to undesired vegetation.

10. The method of claim 9, wherein the herbicidal composition prepared comprises a weight percent ratio of quinclorac and its esters or salts to the ethoxylated lecithin of 0.8:1.0 to 8.0:1.0.

11. The method of claim 10, wherein the herbicidal composition prepared comprises a weight percent ratio of quinclorac and its esters or salts to the ethoxylated lecithin of 1.8:1.

12. The method of claim 11 wherein the herbicidal composition prepared comprises about between about 1% and about 50% of the quinclorac and its esters or salts.

13. The method of claim 12, wherein 20% of the herbicidal composition prepared comprises quinclorac and its esters or salts.

14. The method of claim 13, wherein the herbicidal composition prepared comprises a crop oil concentrate, a methylated seed oil, or a combination thereof.

15. The method of claim 14, wherein the herbicidal composition prepared comprises methylated seed oil, wherein the composition has a volume percent between 0.25% and 5.0% of methylated seed oil.

16. The method of claim 15, wherein the herbicidal composition prepared comprises methylated seed oil, wherein the composition has a volume percent of 1.0% of methylated seed oil.

17. The method of claim 16, wherein the herbicidal composition is applied in sufficient amounts to supply quinclorac and its esters or salts at about 20 to 100 fl oz per acre.

18. The method of claim 17, wherein the herbicidal composition is applied at a rate sufficient to supply 0.1 to 2.0 lb of quinclorac and its esters or salts per acre.

19. The method of claim 18, wherein the herbicidal composition is applied after emergence of undesired vegetation.

20. The method of claim 19, wherein the undesired vegetation is crabgrass.
